(19) United States
(12) Patent Application Publication
(10) Pub. No.: US 2018/0107757 A1
(43) Pub. Date: Apr. 19, 2018

(54) SYSTEM AND METHOD FOR OPTIMIZING AND ENHANCING VISIBILITY OF THE WEBSITE

(71) Applicant: NOWFLOATS TECHNOLOGIES PVT. LTD., Hyderabad (IN)

(72) Inventors: Arpan Samuel RAMTEK, Indore (IN); Ronak Kumar SAMANTRAY, Hyderabad (IN); Ravindra NAIK, Hyderabad (IN); Supriya CHAK, Hyderabad (IN)

(21) Appl. No.: 15/500,849

(22) PCT Filed: Jun. 29, 2016
(86) PCT No.: PCT/IN2016/000169

§ 371 Date: Jan. 31, 2017

(30) Foreign Application Priority Data
Jun. 29, 2015 (IN) 3262/CHE/2015

(51) Int. Cl. G06F 17/30; G06Q 10/06; G06Q 30/02; H04L 29/08

(52) U.S. Cl. CPC G06F 17/30905; G06F 17/30864; G06Q 10/06395; G06F 15/18; G06F 17/3089; H04L 67/26; G06Q 30/0201

(57) ABSTRACT

The present invention provides a method and system for optimizing by intelligently prompting one or more websites to enhance visibility of the website in a search conducted by a search engine and involves configuring one or more rules based on outcome of machine learning by analyzing the search engine configuration and ranking parameters responsible to improve rank of the websites, and dynamically creating a processor adapted to nm multi-threads for each of the one or more websites, analyzing the one or more websites based on the said one or more rules, determining one or more parameters based on the analysis of the one or more websites, and intimating website's owner for one or more actions to be taken based on the one or more parameters through one or more communication medium, thereby enhancing website's chances of discovery.

### RELATED APPLICATION

Benefit is claimed to Indian Provisional Application No. 3262/CHE/2015 titled “SMART COMMUNICATION SYSTEM FOR BUSINESS OWNER ENGAGEMENT AND WEBSITE OPTIMIZATION” filed on 29 Jun. 2015, which is herein incorporated in its entirety by reference for all purposes.

### FIELD OF INVENTION

The present invention relates to search engine optimization and more specifically relates to system and method of optimizing by intelligently prompting one or more websites to enhance visibility of the website in a search conducted by a search engine. The present invention also relates a smart communication system for business owner engagement.

### BACKGROUND OF INVENTION

Websites are a great medium to get any business online, but if they are not discoverable in search engines (like Google, Yahoo etc.), they do not add potential value to the business. Keeping track of every website's activity on a platform is a tedious task and requires lot of man power and since it involves human intervention it might also effect in accuracy. Traditionally, a person was responsible for checking all the changes in the business owner/client/customer's website and sending them emails or sms's encouraging them to take requisite actions. Due to the growing number of customers, it would have required a lot of people, probably hundreds to maintain this.

The business owners/customers/clients might not be aware of the best practices to be followed in order to get better results from different search engines. Currently, there is no system or method that suggests tips to customer which would help the customers in getting their business website discovered online. There is no powerful tool for customer engagement which will help in retention of customers and also to keep track of every customer's action. There is a requirement for tool which also caters to the need of getting the business online and emphasizes more on enhancing its search engine visibility, locally.

Hence, there is a long felt need to have a real time automated customer engagement business to business system to track websites activity, provide engagement with the customers and also automatically suggest the best practices in order to get better results from different search engines.

### SUMMARY

The various embodiments of the present invention disclose a method of optimizing by intelligently prompting one or more websites to enhance visibility of the website in a search conducted by a search engine. The method comprises configuring one or more rules to be applied on the one or more websites, dynamically creating a processor adapted to run multi-threads for each of the one or more websites, analyzing the one or more websites based on the one or more rules, determining one or more parameters based on the analysis of the one or more websites, and intimating to website's owner for one or more actions to be taken based on the one or more parameters through one or more communication medium, thereby enhancing website's chances of discovery.

In an embodiment of the present invention, the method further comprises one or more rules configured based on outcome of machine learning by analyzing the search engine configuration and ranking parameters responsible to improve rank of the website. The one or more communication mediums include short messaging service (SMS), e-mail, and push notification.

In an embodiment of the present invention, each rule of the one or more rules is identified by rule ID. Further, each rule of the one or more rules has a trigger time based on which website is identified for optimization.

In an embodiment of the present invention, each dynamically created processor is identified by a processor ID and each website of the one or more websites is identified by a client ID.

In another embodiment of the invention, a system for optimizing by intelligently prompting one or more websites to enhance visibility of the website in a search conducted by a search engine is disclosed. The system comprises a rule configuring module for configuring one or more rules to be applied on the one or more web sites, a processor creating module connected to the rule configuring module for dynamically creating a processor to run multi-threads for each of the one or more websites, an analyzing module connected to the processor creating module for analyzing the one or more websites based on the one or more rules, a parameter determining module connected to the analyzing module for determining one or more parameters based on the analysis of the one or more websites, and an intimating module connected to the parameter determining module for intimating to website's owner for one or more actions to be taken based on the one or more parameters through one or more communication medium, thereby enhancing website's chances of discovery.

### BRIEF DESCRIPTION OF THE ACCOMPANYING DRAWINGS

The aforementioned aspects and other features of the present invention will be explained in the following description, taken in conjunction with the accompanying drawings, wherein:

FIG. 1 illustrates an environment of smart communication system, according to an embodiment of the present invention.

FIG. 2 illustrates a smart communication agent (RIA) 101, according to an embodiment of the present invention.

FIG. 3 illustrates a Bson document with structure for each run cycle, according to an embodiment of the present invention.

FIG. 4 illustrates a sample of processor in the document with structure, according to an embodiment of the present invention.

FIG. 5 illustrates a sample of SMS log in the document with structure, according to an embodiment of the present invention.

FIG. 6 illustrates a sample of application notification log in the document withstructure, according to an embodiment of the present invention.

FIG. 7 illustrates a sample of email log in the document with structure, according to an embodiment of the present invention.

FIG. 8 illustrates each processor login the document with structure, according to an embodiment of the present invention.

### DETAILED DESCRIPTION OF THE INVENTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present invention, following are the definitions:

The term ‘Processor’ as used or referred in this specification is a thread which executes a certain ruleset provided by the system. ‘Customers’ or ‘clients’ means, unless otherwise mentioned, the respective owners and/or the developers of their website.Extensible Markup Language (XML) is a markup language that defines a set of rules for encoding documents in a format which is both human-readable and machine-readable.

The present invention describes method and system for optimizing by intelligently prompting one or more websites to enhance visibility of the website in a search conducted by a search engine. A smart communication system for business owner engagement is disclosed. The system provides for an automated and regulated search engine optimization of business website through business customer or client engagement via a smart communication agent. The business owners/customers/clients are engaged on periodic or daily basis prompting them valuable information needed to get business leads from web. The smart communication agent is a communication device agent or a web-based agent working on a platform.

According to the invention, the customers/clients are engagedon real time basis, wherein the system observes and analyses the present state of customer's business website. After which a particular action is intelligently decided and executed so as to enhance its chances of discovery in search engine, optimizing it more for local discovery. The decision of selecting a particular action is based upon a prior set of rules or commands that are formulated to optimize the website for search engine, especially local discovery.

These rules or commands set are the outcome of machine learning algorithms, intense research on how search engines (like Google, Yahoo etc.) rank the websites and the parameters which could be tweaked to get a website a better rank when relevant searches are done. Once the action is decided, the smart communication agent suggests or informs the owner of the website at their computer and/or smart digital communication devices to perform the same action on his/her website so as to improve its visibility online. The smart communication agent communicates through all possible communication medium like SMS, email, push notification etc. A log report is maintained for each and every activity done by the smart communication system.

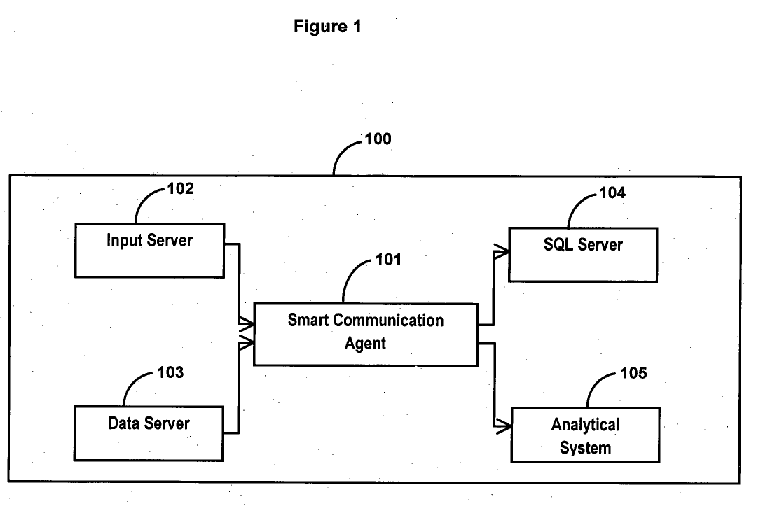

FIG. 1 illustrates an environment of smart communication system, according to an embodiment of the present invention. A system 100 comprises of a smart communication agent (RIA) 101, an input server 102, data server 103, SQL server 104 and an analytical system 105. The input server 102 such as XML provides the smart communication agent 101 with pre-determined location, entries and events based set of rules or commands. The data server 103 such as MongoDB, XQL, etc. retrieves and runs the data, which is then given to the smart communication agent 101. The logs data collected by the smart communication agent 101 is stored in the SQL server 104. The analytical system 105 such as Google analytics runs and reads the updates, activities, and/or visitors logs and/or hitting's over the customer's website. Here, the system is connected both via telecom and computer based communication devices of customers for interactions/communications.

In an embodiment of the present invention, the smart communication agent 101 takes the rulesets from XML and creates the processor for each client. When the system starts running each rule for a client it uses the data server 103 like MongoDB to find details about the client's website. The data is populated and then analyzed. After analyzing the data, the email, SMS and app notifications are sent to the client according to the preferred mode of communication chosen by customer. The smart communication agent 101 saves all the actions in SQL server 104 and uses the analytical system 105 such as Google analytics for tracking all the email and app notification events.

According to an exemplary embodiment of the present invention, the following are some of the scenarios with possible/probable actions where the system sends engagement messages/notifications to the clients. When the website is created, the system prompts the client to update the same. If the customer has not updated the website for a long period and is inactive, he/she is prompted to update the website with deals and offers. For better user engagement, reminders are sent to customer to respond to business enquires that are being sent to customer's website. If description about a business is missing on a website, then prompt the customer to update about business in website. If the customer does not have logo in website, then prompt the customer to include one.

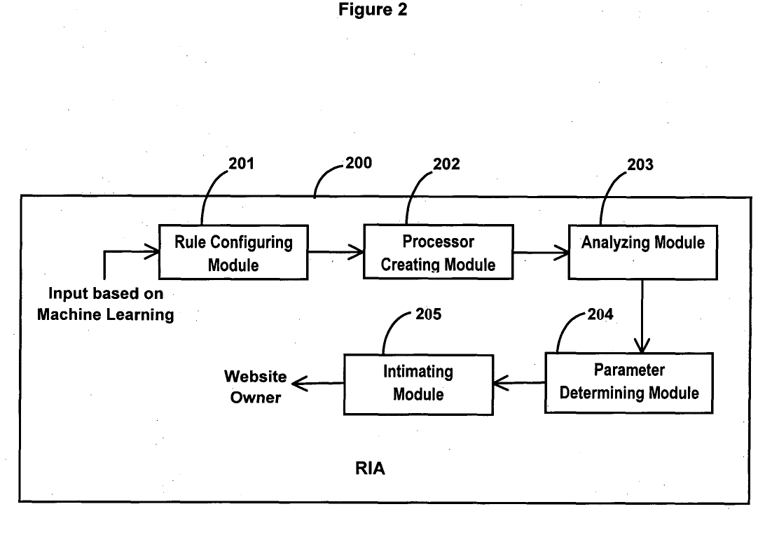

FIG. 2 illustrates a smart communication agent (RIA) 101, according to an embodiment of the present invention. The smart communication agent comprises of a rule configuring module (RCM) 201, a processor creating module (PCM) 202, an analyzing module (AM) 203, a parameter determining module (PDM) 204, an intimating module (IM) 205. The RCM 201 configures one or more rules to be applied on the one or more web sites. After configuring the rules, the PCM 202 which is connected to the RCM 201 dynamically creates a processor to run multi-threads for each of the one or more websites. The AM 203 that is connected to the PCM 202 analyzes the one or more websites based on the one or more rules. Based on the analysis of the one or more websites by the AM 203, the PDM 204 which is connected to the AM 203 determines one or more parameters that improve the visibility of a website. The IM 205 connected to the PDM 204 intimates to website's owner for one or more actions to be taken based on the one or more parameters through one or more communication medium, thereby enhancing website's chances of discovery. In one embodiment, the smart communication agent (RIA) and system can be used interchangeably.

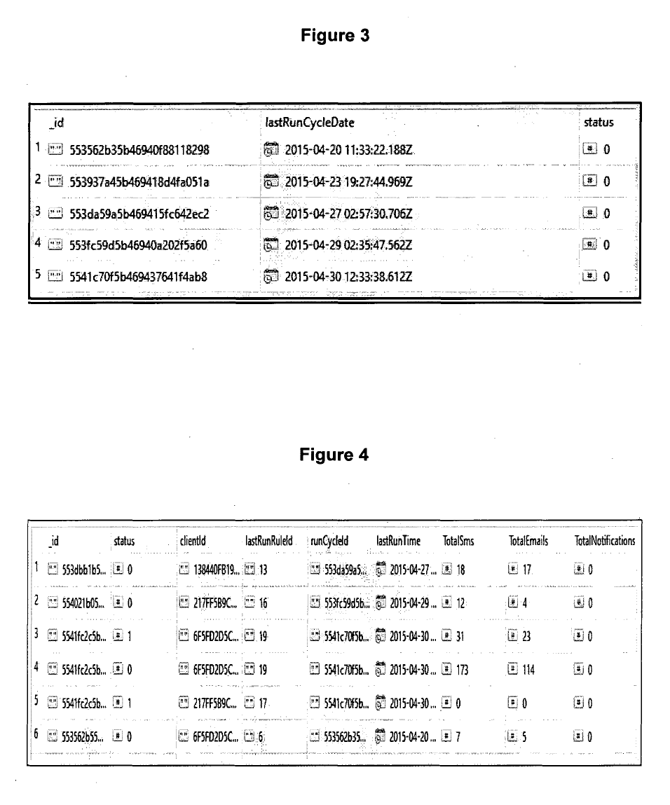

FIG. 3 illustrates a Bson document with structure for each run cycle, according to an embodiment of the present invention. The system operates or runs once a day and it creates a CycleId which is unique for an operation run cycle. All the details about the cycle are saved in a collection“RiaRunCycleAuditLog” in MongoDB. The details comprise CycleId, last run cycle date and status of run cycle.

Further, for every run cycle a processor is created which is unique for every client/customer/website owner. Every client/customer/website owner has a XML from which the system receives list of rules and reads the XML from file system, after which it creates a processor. Every processor has its own unique set of rules which the system executes and each processor is identified by a processor ID which is again unique for a processor. Every rule is identified by rule ID and has a trigger time like the age of website, using which the smart communication agent identifies which websites need to be processed for the rule. Rules could in turn have filter conditions and every rule has different types of communication. The different types of communication are ways the smart communication agent reaches out to its customer like via SMS, email or push notifications in app.

FIG. 4 illustrates a sample of processor in the document with structure, according to an embodiment of the present invention. Every Processor has a unique Id which is a processor Id. Since every client has a processor, each processor is associated with a client Id. Processor comprises of field like status which tells the smart communication agent about the run status of processor. If the status is 0, it indicates that the smart communication agent is running that processor. If the status is −1, it indicates that the smart communication agent has failed in running the processor. If the status is 1, it indicates that the smart communication agent has successfully completed running the processor. Every processor also has a field runCycleId to identify which run cycle the processor belongs to. It keeps logs of notifications that are being sent via channels and also keeps track of date and time at which the processor ran.

The smart communication agent after creating a processor for each of the clients it runs the processor. It reads the time duration of the rule which is normally the age of website and then identifies which website gets matched with that rule. Further the preferable mode of communication opted by the business owner is checked and the notification is added to the respective queue accordingly. The details about the customer's/client's/owner's website are retrieved from MongoDB. Once the website has been identified and the notifications have been added to the queue such as an email, SMS and push notifications, the service is made to run which then sends the notifications to the business/website owners. The actions are logged which includes every action of the smart communication agent till this point in SQL server.

Once the smart communication agent completes running a processor, it marks its status as completed and moves on to the other processors. And before moving on to the other processor, it generates a detailed report of the number of websites that matched for overall rules and the number of SMS, email and push notifications that are added to the queue.

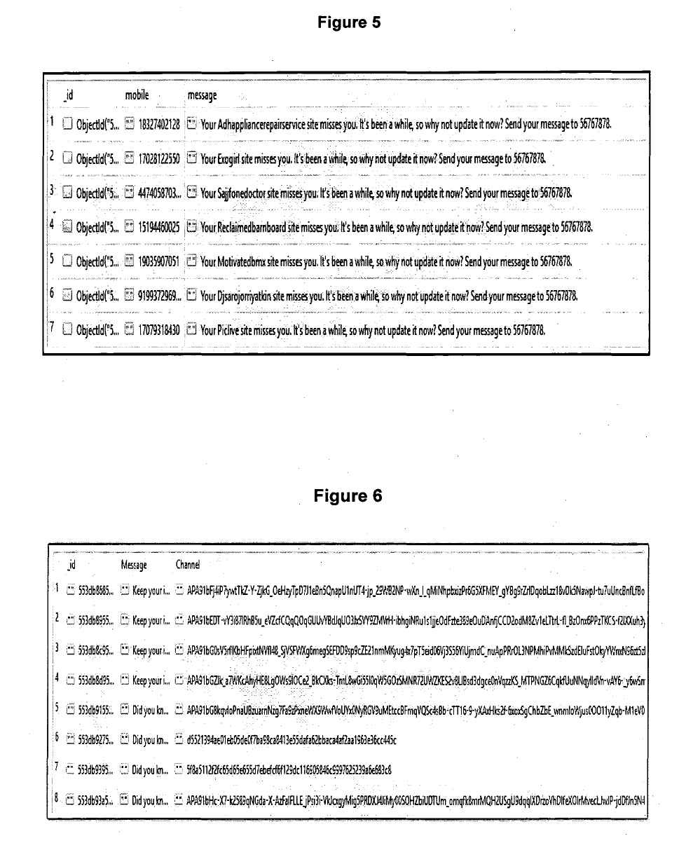

FIG. 5 illustrates a sample of SMS log in the document with structure, according to an embodiment of the present invention. According to the FIG. 5, the field Id is the unique identifier of SMS Id, the field mobile is the number of website owner or customer and the field message contains the text messages that are being sent to the website owner or customer.

FIG. 6 illustrates a sample of application notification log in the document withstructure, according to an embodiment of the present invention. According to the FIG. 6, the field Id represents the notification Id using which one identifies a particular notification, the field message in the notification log includes a message which will be sent to the user in application and the field channel identifies the device to which the message should be sent.

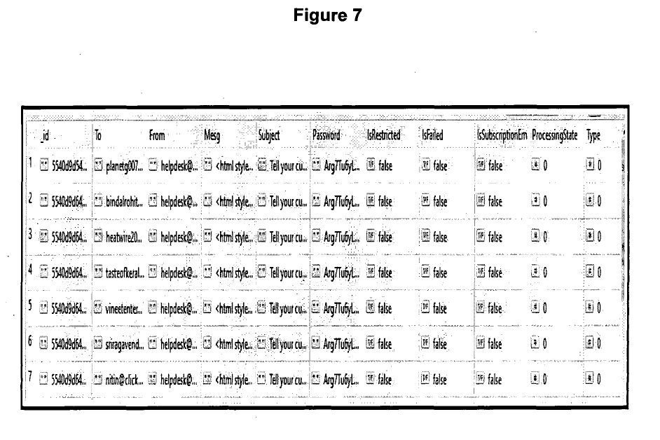

FIG. 7 illustrates a sample of email log in the document with structure, according to an embodiment of the present invention. According to the FIG. 7, the field Id is the unique identifier of the email log, the field ‘To’ represents the recipients email Id and the field ‘From’ represents the senders email id. The email log also has a field ‘Mesg’ which represents the entire body content of the email and the field ‘subject’ represents the subject of the email. The email log further includes the field password which represents the email service from which the email has to be triggered as every client prefers different email service. The status of the email is also marked by using the field ‘ProcessingState’ and its failed variables, if any.

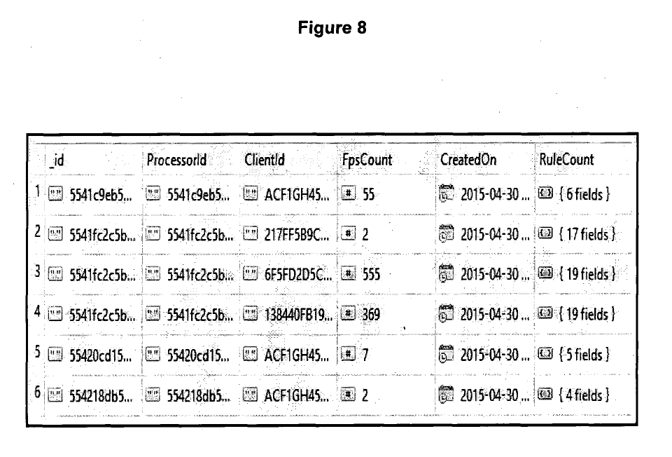

FIG. 8 illustrates each processor log in the document with structure, according to an embodiment of the present invention. According to the FIG. 8, the field Id represents the Processor Id of the Processor log. The Processor log has the information about the client and also the date and time at which the report was generated. The field FPsCount indicates the overall number of websites that were matched for a processor. The dictionary object RuleCount is a key value pair which has rule id as key and the number of websites that were matched for rule id as the value. This information is stored and from here the report is generated for all the clients.

When the smart communication agent completes running all the processors, it marks its status as completed successfully otherwise it updates its status as failed. It saves its every action, from creating a run cycle to sending notifications, in SQL server to keep a log of all its activities. The analytical system like Google analytics is used to keep track of the number of emails and SMS open rate.

Thus, the smart communication agent retrieves the rulesets from XML and creates the processor for each client. When each rule for a client is run it uses MongoDB to find the details about the website. After which the email, SMS and app notifications are details about the website. After which the email, SMS and app notifications are populated according to the preferred mode of communication chosen by the customer. The smart communication agent saves all the actions in SQL server and uses Google analytics for tracking all the email and application notification events.

All equivalent relationships to those illustrated in the drawings and described in the application are intended to be encompassed by the present invention. The examples used to illustrate the embodiments of the present invention, in no way limit the applicability of the present invention to them. It is to be noted that those with ordinary skill in the art will appreciate that various modifications and alternatives to the details could be developed in the light of the overall teachings of the disclosure, without departing from the scope of the invention.

We claim:

1. A method of optimizing by intelligently prompting one or more websites to enhance visibility of the website in a search conducted by a search engine comprising:
configuring one or more rules to be applied on the one or more websites;
dynamically creating a processor adapted to run multi-threads for each of the one or more websites;
analyzing the one or more websites based on the one or more rules;
determining one or more parameters based on the analysis of the one or more websites; and
intimating to website's owner for one or more actions to be taken based on the one or more parameters through one or more communication medium, thereby enhancing website's chances of discovery.

2. The method as claimed in claim 1, wherein the one or more rules are configured based on outcome of machine learning by analyzing the search engine configuration and ranking parameters responsible to improve rank of the website.

3. The method as claimed in claim 1, wherein the one or more communication mediums includes short messaging service (SMS), e-mail, and push notification.

4. The method as claimed in claim 1, wherein each rule of the one or more rules is identified by rule ID.

5. The method as claimed in claim 1, wherein each rule of the one or more rules has a trigger time based on which website is identified for optimization.

6. The method as claimed in claim 1, wherein each dynamically created processor is identified by a processor ID.

7. The method as claimed in claim 1, wherein each website of the one or more websites is identified by a client ID.

8. A system for optimizing by intelligently prompting one or more websites to enhance visibility of the website in a search conducted by a search engine, the system comprising
a rule configuring module for configuring one or more rules to be applied on the one or more web sites;
a processor creating module connected to the rule configuring module for dynamically creating a processor to run multi-threads for each of the one or more websites;
an analyzing module connected to the processor creating module for analyzing the one or more websites based on the one or more rules;
a parameter determining module connected to the analyzing module for determining one or more parameters based on the analysis of the one or more websites; and
an intimating module connected to the parameter determining module for intimating to website's owner for one or more actions to be taken based on the one or more parameters through one or more communication medium, thereby enhancing website's chances of discovery.
